(19) United States
(12) Patent Application Publication
(10) Pub. No.: US 2022/0335377 A1
(43) Pub. Date: Oct. 20, 2022

(54) METHOD AND SYSTEM TO RE-PACK AND USE CANCELLED SHIPMENTS TO SERVE OTHER CUSTOMERS IN THE SAME GEOGRAPHICAL AREA FASTER

(71) Applicant: Flipkart Internet Private Limited, Bangalore (IN)

(72) Inventors: Chaitanya NITTALA, Bangalore (IN); Amit THAKUR, Gurgaon (IN); Vikas JAISWAL, Kanpur (IN)

(21) Appl. No.: 17/720,475

(22) Filed: Apr. 14, 2022

(30) Foreign Application Priority Data
Apr. 14, 2021 (IN) 202141017413

(51) Int. Cl. G06Q 10/08

(52) U.S. Cl. CPC G06Q 10/0837; G06Q 10/0835; G06Q 10/0836; H04W 4/025

(57) ABSTRACT

An order placement system comprises an order placement module, a first transfer module, a second transfer module, and a detection module. The order placement module prompts a first customer from a geographical location to place an order for a consignment. The first transfer module is controlled by the processor and in communication with the order placement module to send instructions to transfer the ordered consignment to a delivery hub. The second transfer module sends instructions to the delivery hub when the first customer cancels the ordered consignment, and the cancelled consignment is returned to the delivery hub. The detection module identifies a second customer in the same geographical location who ordered the same consignment that was cancelled by the first customer. The second transfer module provides instructions to the delivery hub to deliver the same consignment to the second customer, where a reverse shipment of the cancelled consignment is avoided.

### FIELD OF THE INVENTION

The present invention is related to the field of logistics associated with delivery of shipments to different geographical areas, more specifically, a method and system to re-pack and use cancelled shipments to serve other customers in the same geographical area faster. The method and system belong to the e-commerce field and lies in the intersection of order-management system and supply chain management.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

In the current scenario of order-management system and supply chain management, once an order is cancelled by a customer, the corresponding shipment is shipped or returned all the way back to its origin, which is also termed as “reverse shipment”. This process of reverse shipment involves almost the same transporting cost as that of the delivery cost, and therefore adds to the total cost of delivery of the shipment. Furthermore, reverse shipment also affects overall delivery schedules, loading of transport vehicles returning shipments to the original warehouses, and occupancy of space in the warehouse that can be utilized for later shipments. This scenario is clearly explained in FIG. 1.

In view of the above issues, there is a need for an intelligent method and system that understands features from a first customer's order and re-directs the shipment to a second customer within the same locality or geographical location as that of the first customer, and this will effectively reduce the issue of reverse shipment.

### SUMMARY OF THE INVENTION

It is intended that all such features, and advantages be included within this description, be within the scope of the present invention, and be protected by the accompanying claims. The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

The solution for the aforementioned issues involves a machine learning method that uses features from customers' history and cancelled products to estimate the propensity of re-use of a cancelled order. Based on this propensity, the reverse shipment is repacked and reused within the same geographical area. This has two benefits: (1) The machine learning method saves the cost of reverse shipment, reduces effective cancellations in the e-commerce marketplace and (2) The machine learning method increases speed of delivery when the cancelled products are ordered next time from the same geographical area (as the cancelled customer). Furthermore, the solution disclosed here is a process that combines machine learning using the data from order management system and applying the data efficiently in the supply chain. The method and system provide new uses for existing supply chain operations.

In other words, an order placement system is disclosed here that comprises at least one processor that operates under control of a stored program comprising a sequence of program instructions to control multiple components. The components comprise an order placement module, a first transfer module, a second transfer module, and a detection module. The order placement module prompts a first customer from a geographical location to place an order for a consignment. The first transfer module is controlled by the processor and in communication with the order placement module to send instructions to transfer the ordered consignment to a delivery hub. The second transfer module is controlled by the processor to send instructions to the delivery hub when the first customer cancels the ordered consignment, and the cancelled consignment is returned to the delivery hub. The detection module is controlled by the processor to identify a second customer in the same geographical location who ordered the same consignment that was cancelled by the first customer.

The second transfer module provides instructions to the delivery hub to deliver the same consignment to the second customer, where a reverse shipment of the cancelled consignment is avoided. In an embodiment, the first customer uses the order placement module to place the order for the consignment via an internet service and the ordered consignment is first procured in a warehouse. In an embodiment, the instructions are sent to the warehouse using the first transfer module to transfer the ordered consignment to a mother hub and subsequently to the delivery hub. In an embodiment, the first customer cancels the ordered consignment and places a return to origin (RTO) request to return the cancelled consignment to the delivery hub.

### BRIEF DESCRIPTION OF DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 exemplarily illustrates a schematic diagram showing a typical order-management system and supply chain management involving reverse shipment, according to the prior art.

FIG. 2 exemplarily illustrates a schematic diagram that shows a proposed method and system to avoid the reverse shipment as discussed in FIG. 1.

FIG. 3 exemplarily illustrates a method based on a computer program product to place an order via an order placement system comprising a processor and memory storing instructions.

### DESCRIPTION OF THE INVENTION

The aim of the present invention is to introduce a machine learning method and system that uses features from customers' history and cancelled product to estimate the propensity of re-use of a cancelled order. The foregoing advantages as well as the working of the machine learning method and system to estimate the propensity of re-use of a cancelled order will become more noticeable and understandable from the following detail description thereof when read in conjunction with the accompanying drawings.

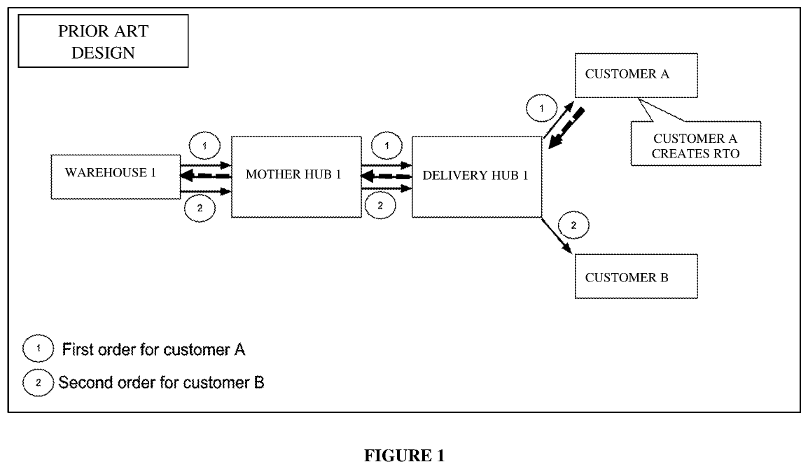

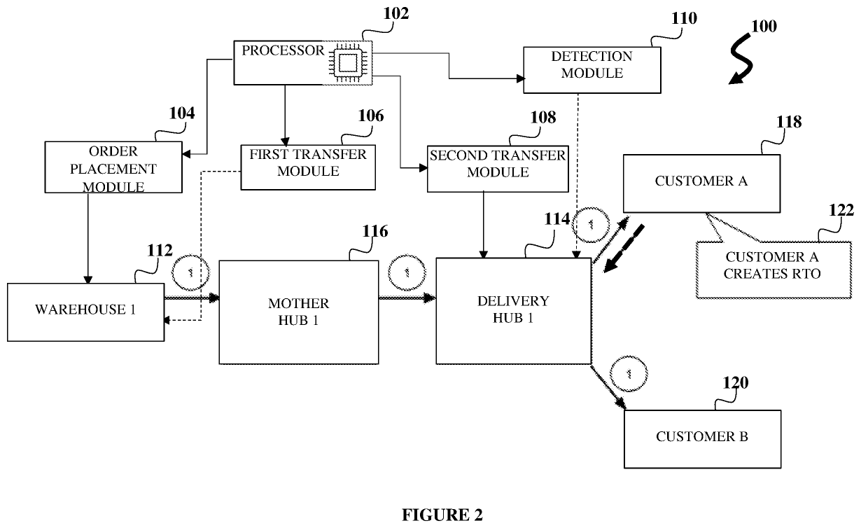

FIG. 2 exemplarily illustrates a schematic diagram that shows a proposed method and system to avoid the reverse shipment as discussed in FIG. 1. The reverse shipping system applies machine learning to increase efficiency in usage of cancelled shipments. The reverse shipping system involves calculation and use of the propensity of cancellation and re-use of every order which are machine-learnt from the information of the customer and product to decide the number of days to retain the cancelled shipment.

FIG. 2 is the schematic that explains the change from existing system that is shown in FIG. 1. In the above schematic diagram, Customer A and Customer B are in the same geographical area, which is defined by the serviceable catchment area of the e-commerce supply chain. The system is used to re-use cancelled shipments for other customers without going back to origin. The system is used to reduce shipments directly from the origin based on the propensity of cancellation of the order and availability of cancelled shipments at the destination. The SLAs to serve customers is reduced by reducing shipping time.

As disclosed in FIG. 2, an order placement system 100 is disclosed herein comprising at least one processor 102 that operates under control of a stored program comprising a sequence of program instructions to control one or more components. The components comprise an order placement module 104, a first transfer module 106, a second transfer module 108, and a detection module 110. The order placement module 104 prompts a first customer 118 from a geographical location to place an order for a consignment. The first customer 118 uses the order placement module 104 to place the order for the consignment via an internet service, for example, an e-commerce website, and the ordered consignment is first procured in a warehouse 112.

The first transfer module 106 is controlled by the processor 102 and in communication with the order placement module 104 to send instructions to transfer the ordered consignment to a delivery hub 114. The instructions are sent to the warehouse 112 using the first transfer module 106 to transfer the ordered consignment to a mother hub 116 and subsequently to the delivery hub 114. The second transfer module 108 is controlled by the processor 102 to send instructions to the delivery hub 114 when the first customer 118 cancels the ordered consignment, and the cancelled consignment is returned to the delivery hub 114. The first customer 118 cancels the ordered consignment and places a return to origin (RTO) request 122 to return the cancelled consignment to the delivery hub 114. The detection module 110 is controlled by the processor 102 to identify a second customer 120 in the same geographical location who ordered the same consignment that was cancelled by the first customer 118. The second transfer module 108 provides instructions to the delivery hub 114 to deliver the same consignment to the second customer 120, where a reverse shipment of the cancelled consignment is avoided.

In other words, as shown in FIG. 2, an order placement system 100 is controlled by a processor 102 places the order for a shipment or consignment via an e-commerce website and the ordered shipment is first procured in the warehouse 112. A first transfer module 106 controlled by the processor 102 sends instructions to the warehouse 112 to transfer the shipment to a mother hub 116 and subsequently to delivery hub 114. When the customer A cancels the order and places a return to origin (RTO) request, the shipment is returned to delivery hub 114 as per instructions from a second transfer module 108 controlled by the processor 102. Consequently, the detection module 110 controlled by the processor 102 identifies a customer B in the same geographical location who ordered the same consignment and provides instruction to the delivery hub 114 to deliver the same consignment to the customer B, whereby the reverse shipment to the warehouse 112 is effectively avoided in the process.

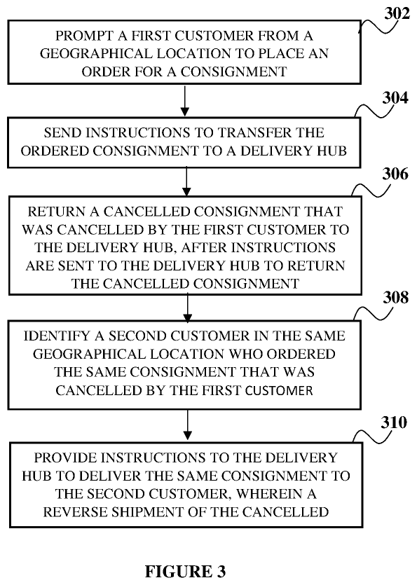

FIG. 3 exemplarily illustrates a method based on a computer program product to place an order via an order placement system comprising a processor 102 and memory storing instructions. The order placement system 100 comprises a processor 102 that operates under control of a stored program comprising a sequence of program instructions to control one or more components. The components comprise an order placement module 104, a first transfer module 106, a second transfer module 108, and a detection module 110. The order placement module 104 prompts 302 a first customer 118 from a geographical location to place an order for a consignment.

The first transfer module 106 is controlled by the processor 102 and in communication with the order placement module 104 to send 304 instructions to transfer the ordered consignment to a delivery hub 114. The second transfer module 108 is controlled by the processor 102 to send instructions to the delivery hub 114 when the first customer 118 cancels the ordered consignment, and the cancelled consignment is returned 306 to the delivery hub 114. The detection module 110 is controlled by the processor 102 to identify 308 a second customer 120 in the same geographical location who ordered the same consignment that was cancelled by the first customer 118. The second transfer module 108 provides instructions 310 to the delivery hub 114 to deliver the same consignment to the second customer 120, where a reverse shipment of the cancelled consignment is avoided.

As will be appreciated by one of skill in the art, the present disclosure may be embodied as a method and system. Accordingly, the present disclosure may take the form of an entirely hardware embodiment, a software embodiment or an embodiment combining software and hardware aspects.

It will be understood that the functions of any of the units as described above can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts performed by any of the units as described above.

Instructions may also be stored in a computer-readable memory that can direct a computer or other programmable data processing apparatus to function in a particular manner, such that the instructions stored in the computer-readable memory produce an article of manufacture including instruction means which implement the function/act performed by any of the units as described above.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts performed by any of the units as described above.

In the specification, there has been disclosed exemplary embodiments of the invention. Although specific terms are employed, they are used in a generic and descriptive sense only and not for purposes of limitation of the scope of the invention.

We claim:

1. An order placement system comprising:
at least one processor that operates under control of a stored program comprising a sequence of program instructions to control one or more components, wherein the components comprising:
an order placement module that prompts a first customer from a geographical location to place an order for a consignment;
a first transfer module controlled by the processor and in communication with the order placement module, sends instructions to transfer the ordered consignment to a delivery hub;
a second transfer module controlled by the processor sending instructions to the delivery hub when the first customer cancels the ordered consignment, and wherein the cancelled consignment is returned to the delivery hub;
a detection module controlled by the processor identifies a second customer in the same geographical location who ordered the same consignment that was cancelled by the first customer; and
the second transfer module providing instructions to the delivery hub to deliver the same consignment to the second customer, wherein a reverse shipment of the cancelled consignment is avoided.

2. The order placement system as claimed in claim 1, wherein the first customer uses the order placement module to place the order for the consignment via an internet service and the ordered consignment is first procured in a warehouse.

3. The order placement system as claimed in claim 2, wherein the instructions are send to the warehouse using the first transfer module to transfer the ordered consignment to a mother hub and subsequently to the delivery hub;

4. The order placement system as claimed in claim 3, wherein the first customer cancels the ordered consignment and places a return to origin (RTO) request to return the cancelled consignment to the delivery hub.

5. A method to place an order via an order placement system, the method comprising:
at least one processor that operates under control of a stored program comprising a sequence of program instructions to control one or more components, wherein the instructions comprising:
prompting a first customer from a geographical location via an order placement module, to place an order for a consignment;
sending instructions to transfer the ordered consignment to a delivery hub, via a first transfer module controlled by the processor and in communication with the order placement module;
returning a cancelled consignment that was cancelled by the first customer to the delivery hub, via a second transfer module controlled by the processor that sends instructions to the delivery hub to return the cancelled consignment;
identifying, via a detection module controlled by the processor, a second customer in the same geographical location who ordered the same consignment that was cancelled by the first customer; and
providing instructions to the delivery hub, via the second transfer module, to deliver the same consignment to the second customer, wherein a reverse shipment of the cancelled consignment is avoided.

6. The method as claimed in claim 5, comprising placing order for the consignment via an internet service and presenting the ordered consignment in a warehouse.

7. The method as claimed in claim 6, comprising sending the instructions to the warehouse to transfer the ordered consignment to a mother hub and subsequently to the delivery hub;

8. The method as claimed in claim 7, comprising:
cancelling the ordered consignment by the first customer; and
placing a return to origin (RTO) request to return the cancelled consignment to the delivery hub.

9. A computer program product to place an order via an order placement system comprising a processor and memory storing instructions thereon, wherein the instructions when executed by the processor causes the processor to:
prompt a first customer from a geographical location to place an order for a consignment;
send instructions to transfer the ordered consignment to a delivery hub;
return a cancelled consignment that was cancelled by the first customer to the delivery hub, after instructions are sent to the delivery hub to return the cancelled consignment;
identify a second customer in the same geographical location who ordered the same consignment that was cancelled by the first customer; and
provide instructions to the delivery hub to deliver the same consignment to the second customer, wherein a reverse shipment of the cancelled consignment is avoided.
